(19) United States
(12) Patent Application Publication
(10) Pub. No.: US 2023/0191944 A1
(43) Pub. Date: Jun. 22, 2023

(54) APPARATUS AND METHODS FOR ENSURING AVAILABILITY OF DESIGNATED ELECTRIC VEHICLES DURING AN EMERGENCY

(71) Applicant: HERE GLOBAL B.V., Eindhoven (NL)

(72) Inventors: Jerome Beaurepaire, Berlin (DE); Marko Tuukkanen, Schienzer (DE)

(73) Assignee: HERE GLOBAL B.V., Eindhoven (NL)

(21) Appl. No.: 17/559,213

(22) Filed: Dec. 22, 2021

(51) Int. Cl. B60L 58/13; B60L 50/15

(52) U.S. Cl. CPC B60L 58/13; B60L 50/15; B60L 2260/52; B60L 2260/54

(57) ABSTRACT

An apparatus, method and computer program product are provided for providing availability of designated electric vehicles during an emergency. In one example, the apparatus receives a mobility pattern of a user of an electric vehicle and adds the user and the electric vehicle to an exception list based on the mobility pattern. During an emergency, the apparatus ensures a predetermined amount of state of charge for each electric vehicle that is electrically coupled to an external power source and is indicated in the exception list.

### TECHNICAL FIELD

The present disclosure generally relates to the field of energy management, associated methods and apparatus, and in particular, concerns, for example, an apparatus configured to ensure a predetermined amount of state of charge for designated electric vehicles during an emergency.

### BACKGROUND

During emergencies, such as fire, flood, etc., operations associated with infrastructures may be ceased or altered to mitigate severity of such situations. As such, services provided via said operations may be unavailable for certain consumers of said services. One of such services may be associated with electric power, and as such, consumers of said service may be unable to charge critical devices, equipment, etc. during the emergencies. In some scenarios, lack of power distribution during emergencies can increase the severity of the situations. For example, a consumer having a critical role for emergencies (e.g., a first responder) may be unable to perform or be hindered from performing a designated duty thereof during the emergencies due to a state of charge the consumer's essential device, such as an electric vehicle, having an insufficient amount of charge. Therefore, there is a need for remedying such scenarios.

The listing or discussion of a prior-published document or any background in this specification should not necessarily be taken as an acknowledgement that the document or background is part of the state of the art or is common general knowledge.

### BRIEF SUMMARY

According to a first aspect, an apparatus comprising at least one processor and at least one non-transitory memory including computer program code instructions is described. The computer program code instructions, when executed, cause the apparatus to limit power distributed from an external power source to a plurality of electric vehicles during an emergency and during the emergency, provide an exception of power distribution from the external power source to a subset of the plurality of electric vehicles. The exception ensures a predetermined amount of state of charge for each of the subset during the emergency. The exception is established at least in part by a mobility pattern of a user of each of the plurality of electric vehicles.

According to a second aspect, a non-transitory computer-readable storage medium having computer program code instructions stored therein is described. The computer program code instructions, when executed by at least one processor, cause the at least one processor to receive a mobility pattern of a user of an electric vehicle, based on the mobility pattern, add the user and the electric vehicle to an exception list, and during an emergency, ensure a predetermined amount of state of charge for each electric vehicle that is electrically coupled to an external power source and is indicated in the exception list.

According to a third aspect, a method of ensuring availability of electric vehicles during an emergency is described. The method includes receiving a mobility pattern of a user of an electric vehicle, based on the mobility pattern, adding the user and the electric vehicle to an exception list, during a non-emergency, providing a notification of a predetermined amount of state of charge for each electric vehicle indicated in the exception list, and during the emergency, ensuring the predetermined amount of state of charge for each electric vehicle that is coupled to an external power source and is indicated in the exception list.

Also, a computer program product may be provided. For example, a computer program product comprising instructions which, when the program is executed by a computer, cause the computer to carry out the steps described herein.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed herein are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

### BRIEF DESCRIPTION OF THE DRAWINGS

The embodiments of the invention are illustrated by way of example, and not by way of limitation, in the figures of the accompanying drawings:

FIG. 1 illustrates a diagram of a system capable of providing availability of designated electric vehicles during an emergency;

FIG. 2 illustrates a diagram of the database within the system of FIG. 1;

FIG. 3 illustrates a diagram of the components of the assessment platform within the system of FIG. 2;

FIG. 4 illustrates example exception lists established by the calculation module of FIG. 3;

FIG. 5 illustrates a first example visual representation of a prompt provided to a designated electric vehicle user during an emergency;

FIG. 6 illustrates a second example visual representation of a notification for ensuring availability of a designated electric vehicle;

FIG. 7 illustrates a flowchart of a process for selectively providing power to electric vehicles during an emergency;

FIG. 8 illustrates a flowchart of a process for ensuring availability of designated electric vehicles during an emergency;

FIG. 9 illustrates a computer system upon which an embodiment may be implemented;

FIG. 10 illustrates a chip set or chip upon which an embodiment may be implemented; and

FIG. 11 illustrates a diagram of exemplary components of a mobile terminal for communications, which is capable of operating in the system of FIG. 1.

### DETAILED DESCRIPTION

During emergencies, electric power suppliers may be instructed to redistribute and/or discontinue power provided to consumers in efforts to mitigate severity of the emergencies. In some scenarios, certain consumers having critical roles for the emergencies, such as first responders, may be impacted by such limitation of electric power, thereby hindering or completely preventing such consumers from performing designated duties thereof for the emergencies. For example, doctors, firefighters, and other first responders may be users of electric vehicles, and at a time of an emergency, such consumers may be attempting to charge the electric vehicles at residential charging locations and be unable to reach point-of-interests (POIs) designated for emergencies (e.g., hospitals, fire departments, etc.) due to the electric vehicles having an insufficient amount of charge for reaching the designated POIs. There will now be described an apparatus and associated methods that may address these issues.

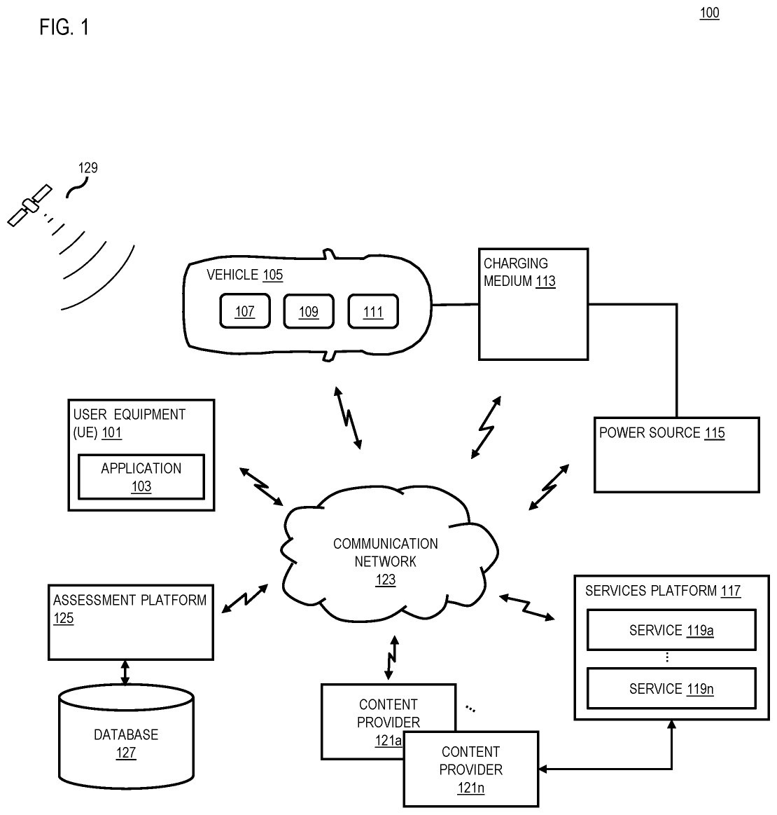

FIG. 1 is a diagram of a system 100 capable of providing availability of designated electric vehicles during an emergency, according to one embodiment. Herein, a designated electric vehicle is an electric vehicle that is permitted to acquire electric power from a power supplier while other electric vehicles are limited from acquiring or not permitted to acquire electric power from the power supplier during an emergency. Herein, an emergency refers to an event in which natural disasters, accidents, and/or other abnormal circumstances that interrupts (or has the potential to interrupt) distribution of power from a power supplier to consumers. The system includes a user equipment (UE) 101, a vehicle 105, a charging medium 113, a power source 115, a services platform 117, content providers 121a-121n, a communication network 123, an assessment platform 125, a database 127, and a satellite 129. Additional or a plurality of mentioned components may be provided.

In the illustrated embodiment, the system 100 comprises a user equipment (UE) 101 that may include or be associated with an application 103. In one embodiment, the UE 101 has connectivity to the assessment platform 125 via the communication network 123. The assessment platform 125 performs one or more functions associated with providing availability of designated electric vehicles during an emergency. In the illustrated embodiment, the UE 101 may be any type of mobile terminal or fixed terminal such as a mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, devices associated with or integrated with one or more vehicles (including the vehicle 105), or any combination thereof, including the accessories and peripherals of these devices. In one embodiment, the UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the UE 101 can be a cellular telephone. A user may use the UE 101 for navigation functions, for example, road link map updates. It should be appreciated that the UE 101 can support any type of interface to the user (such as “wearable” devices, etc.). In one embodiment, the one or more vehicles may have cellular or Wi-Fi connection either through the inbuilt communication equipment or from the UE 101 associated with the vehicles. The application 103 may assist in conveying and/or receiving information regarding emergencies and designated electric vehicles via the communication network 123.

In the illustrated embodiment, the application 103 may be any type of application that is executable by the UE 101, such as a mapping application, a location-based service application, a navigation application, a content provisioning service, a camera/imaging application, a media player application, a social networking application, a calendar application, or any combination thereof. In one embodiment, one of the applications 103 at the UE 101 may act as a client for the assessment platform 125 and perform one or more functions associated with the functions of the assessment platform 125 by interacting with the assessment platform 125 over the communication network 123. The application 103 may provide information associated with designated electric vehicles and be used to acquire information associated with users of electric vehicles for assigning one or more of the electric vehicles as one or more designated electric vehicles.

The vehicle 105 is an electric vehicle. The vehicle 105 is equipped with an electric motor, a power supply for driving the electric motor, a charging port for electrically coupling with a charging medium (such as the charging medium 113), an external power supply, another electric vehicle, and/or other electrically powered devices. The vehicle 105 may be a non-autonomous vehicle or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle 105 may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle 105, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, the UE 101 may be integrated in the vehicle 105, which may include assisted driving vehicles such as autonomous vehicles, highly assisted driving (HAD), and advanced driving assistance systems (ADAS). Any of these assisted driving systems may be incorporated into the UE 101. Alternatively, an assisted driving device may be included in the vehicle 105. The assisted driving device may include memory, a processor, and systems to communicate with the UE 101. In one embodiment, the vehicle 105 may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such vehicle may also be driven in a manual mode in which the human operator exercises a degree of control over the movement of the vehicle. The vehicle 105 may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In this illustrated example, the vehicle 105 includes a plurality of sensors 107, an on-board computing platform 109, and an on-board communication platform 111. The sensors 107 may be current/voltage sensors for detecting a state of charge of the vehicle 105, amount of power provided to the vehicle 105, amount of power used by the vehicle, etc. The sensors 107 may be image sensors (e.g., electronic imaging devices of both analog and digital types, which include digital cameras, camera modules, camera phones, thermal imaging devices, radar, sonar, lidar, etc.), a global positioning sensor for gathering location data, a network detection sensor for detecting wireless signals or receivers for different short-range communications (e.g., Bluetooth, Wi-Fi, Li-Fi, near field communication (NFC), etc.), temporal information sensors, an audio recorder for gathering audio data, velocity sensors, light sensors, oriental sensors augmented with height sensor and acceleration sensor, tilt sensors to detect the degree of incline or decline of the vehicle 105 along a path of travel, tire pressure sensors, temperature sensors, etc. In a further embodiment, sensors about the perimeter of the vehicle 105 may detect the relative distance of the vehicle 105 from road objects (e.g., road markings), lanes, or roadways, the presence of other vehicles, pedestrians, traffic lights, road objects, road features (e.g., curves) and any other objects, or a combination thereof. In one embodiment, the vehicle 105 may include GPS receivers to obtain geographic coordinates from satellites 129 for determining current location and time associated with the vehicle 105. Further, the location can be determined by a triangulation system such as A-GPS, Cell of Origin, or other location extrapolation technologies.

The on-board computing platform 109 performs one or more functions associated with the vehicle 105. In one embodiment, the on-board computing platform 109 may aggregate sensor data generated by at least one of the sensors 107 and transmit the sensor data via the on-board communications platform 111. The on-board computing platform 109 may receive control signals for performing one or more of the functions from the assessment platform 125, the UE 101, the services platform 117, one or more of the content providers 121a-121n, or a combination thereof via the on-board communication platform 111. The on-board computing platform 109 includes at least one processor or controller and memory (not illustrated). The processor or controller may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory includes multiple kinds of memory, particularly volatile memory and non-volatile memory.

The on-board communications platform 109 includes wired or wireless network interfaces to enable communication with external networks. The on-board communications platform 109 also includes hardware (e.g., processors, memory, storage, antenna, etc.) and software to control the wired or wireless network interfaces. In the illustrated example, the on-board communications platform 109 includes one or more communication controllers (not illustrated) for standards-based networks (e.g., Global System for Mobile Communications (GSM), Universal Mobile Telecommunications System (UMTS), Long Term Evolution (LTE) networks, 5G networks, Code Division Multiple Access (CDMA), WiMAX (IEEE 802.16m); Near Field Communication (NFC); local area wireless network (including IEEE 802.11 a/b/g/n/ac or others), dedicated short range communication (DSRC), and Wireless Gigabit (IEEE 802.11ad), etc.). In some examples, the on-board communications platform 109 includes a wired or wireless interface (e.g., an auxiliary port, a Universal Serial Bus (USB) port, a Bluetooth® wireless node, etc.) to communicatively couple with the UE 101.

The charging medium 113 is a stationary device that is capable of being electrically coupled with the vehicle 105. The charging medium 113 functions as a medium for supplying power from the power source 115 to the vehicle 105 that is electrically coupled to the charging medium 113. In one embodiment, the charging medium 113 may be a charging station. In another embodiment, the charging medium 113 may be defined based on a location in which power is drawn. For example, the charging medium 113 may be defined by an outlet (and cables and/or other devices for supplementing provision of power from the outlet to an electric vehicle) of a building (e.g., residential or non-residential buildings) or a portion thereof. In one embodiment, a charging station may be equipped with hardware and software for providing information to a consumer using the charging station, a power supplier (not illustrated) of the charging station, or a combination thereof. Such information may indicate: (1) an amount of power drawn; (2) information associated with a vehicle/user that is using the charging station; (3) an estimated time to a desired state of charge; (4) availability of the charging station; (5) a charging station reservation list; (6) other relevant information; or (7) a combination thereof. In one embodiment, a power supplier may identify a location as the charging medium 113 based on power consumption history, vehicle mobility data, or a combination thereof. For example, the power consumption history may indicate one or more periods in which a predetermined amount of power is drawn at a location, and the vehicle mobility data may indicate one or more periods in which a vehicle is stationed at the location. If the power consumption history and the vehicle mobility data correspond to each other, the power supplier may determine that the location operates as the charging medium 113. In one embodiment, the UE 101 or other user equipment may transmit information to the power supplier to indicate that a location is being used as the charging medium 113.

The power source 115 may be a power station, a power plant, or another power generating/storing establishment that are electrically coupled to an electrical grid. The power source 115 may provide electrical power to a plurality of consumers within a region via the electrical grid. In one embodiment, the power source 115 may be controlled/maintained by a power supplier. The power supplier may be defined at least part by the services platform 117, the assessment platform 125, and/or other platform (not illustrated) communicatively coupled to the communication network 123. In one embodiment, the power supplier may acquire information associated with amount of power generated, stored, and consumed and may transmit the information and/or other relevant information to the assessment platform 125 for aiding in the provision of availability of designated electric vehicles during an emergency. In one embodiment, the power supplier may: (1) receive information regarding one or more locations impacted by an adverse condition (e.g., an emergency); (2) determine whether one or more portions of the electric grid is impacted by the adverse condition; (3) limit or discontinue power supplied to the one or more portions of the electric grid based on the determination; and (4) provide information associated with the limitation or discontinuation of power associated with the one or more portions to one or more entities communicatively coupled to the communication network 123.

The communication network 123 of system 100 includes one or more networks such as a data network, a wireless network, a telephony network, or any combination thereof. The data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The services platform 117 may provide one or more services 119a-119n (collectively referred to as services 119), such as mapping services, navigation services, travel planning services, weather-based services, emergency-based services, notification services, social networking services, content (e.g., audio, video, images, etc.) provisioning services, application services, storage services, contextual information determination services, location-based services, information-based services, etc. In one embodiment, the services platform 117 may be an original equipment manufacturer (OEM) platform. In one embodiment the one or more service 119 may be sensor data collection services. By way of example, vehicle sensor data provided by the sensors 107 may be transferred to the UE 101, the assessment platform 125, the database 127, or other entities communicatively coupled to the communication network 123 through the service platform 115. In one embodiment, the services platform 117 uses the output data generated by of the assessment platform 125 to provide services such as navigation, mapping, other location-based services, etc. In one embodiment, the services platform 117 may be a power supplying platform that maintains/controls the power source 115 and aggregates or generates information associated with distribution of power, power consumption, and power generation. The service platform 117 may also store information associated with one or more charging media 113 and determine whether one or more locations in which power is drawn is being used as a charging medium 113. Such information may be provided to the assessment platform 125 for aiding in the provision of availability of designated vehicles during an emergency. In one embodiment, the services platform 117 may be a platform or a database that maintains and/or validates credentials of one or more persons, such as employment history.

In one embodiment, the content providers 121a-121n (collectively referred to as content providers 121) may provide content or data (e.g., including geographic data, parametric representations of mapped features, etc.) to the UE 101, the vehicle 105, services platform 117, the vehicle 105, the database 127, the assessment platform 125, or the combination thereof. In one embodiment, the content provided may be any type of content, such as map content, textual content, audio content, video content, image content, etc. In one embodiment, the content providers 121 may provide content that may aid in providing availability of designated vehicles during an emergency, and/or other related characteristics. In one embodiment, the content providers 121 may also store content associated with the UE 101, the vehicle 105, services platform 117, the vehicle 105, the database 127, the assessment platform 125, or the combination thereof. In another embodiment, the content providers 121 may manage access to a central repository of data, and offer a consistent, standard interface to data, such as a repository of the database 127.

In the illustrated embodiment, the assessment platform 125 may be a platform with multiple interconnected components. The assessment platform 125 may include multiple servers, intelligent networking devices, computing devices, components and corresponding software for providing availability of designated electric vehicles during an emergency. It should be appreciated that that the assessment platform 125 may be a separate entity of the system 100, included within the UE 101 (e.g., as part of the applications 103), included within the vehicle 105 (e.g., as part of an application stored in memory of the on-board computing platform 109), included within the services platform 117 (e.g., as part of an application stored in server memory for the services platform 117), other platforms embodying a power supplier (not illustrated), or a combination thereof.

During an emergency, a power supplier may limit and/or deactivate power provided to one or more regions of an electric grid. The assessment platform 125 ensures that one or more designated electric vehicles can be charged during such circumstance. Specifically, the assessment platform 125: (1) determines a role of a user/vehicle; (2) determines a priority of the role in relation to an emergency; (3) adds the user/vehicle to an exception list based on the priority; (4) ensures a predetermined state of charge for each user/vehicle as indicated in the exception list during the emergency. Herein, electric vehicles added in the exception list will be referred as designated electric vehicles. An electric vehicle described herein should be deemed to exemplify the vehicle 105 or embody one or more features of the vehicle 105.

The assessment platform 125 maintains the exception list and adds a user and an electric vehicle thereof based on a role of the user. The role may be defined by the user's social connections, responsibilities, work obligations, etc. In one embodiment, the assessment platform 125 receives a request (e.g., from the UE 101) for a user of an electric vehicle to be added to the exception list. In response, the assessment platform 125 may acquire information indicating a role of the user from one or more sources (e.g., the database 127, the services platform 117, or other database/platform that provides information associated with a user).

In one embodiment, the assessment platform 125 validates the role based on a comparison between a mobility pattern (e.g., mobility data) of the user and one or more POIs associated with the role of the user. Specifically, the assessment platform 125 acquires the mobility pattern and/or a user location history via, for instance, location data (e.g., Global Positioning System (GPS) or equivalent data) recorded by a user device and/or a vehicle (e.g., UE 101 and/or vehicle 105), other sensor data from user devices and/or vehicles, IP addresses of Wi-Fi access points, cell towers, and/or Bluetooth-enabled devices of other users and/or entities, private, public, and/or national surveillance systems (e.g., via cameras, satellites, internet, etc.), social media location check-in data, etc. The mobility pattern may indicate when and where the user travels to a location, and the used mode(s) of transport (i.e., checked-out), when and where each mode of transport is released (i.e., checked-in), how long the user stays at a given location, where the user is located within the threshold proximity to a point of interest (e.g., restaurant, supermarket, park, etc.) at a given time, correlations that can be made relative to other factors such as weather, events, day of the week, etc. Further, the assessment platform 125 determines the one or more POIs based on the role of the user. For example, if a role indicates that a user is a doctor, a POI associated with the role may be a hospital. Once the mobility pattern and the one or more POIs associated with the role is determined, the assessment platform 125 determines a degree at which the one or more POIs is related with the mobility pattern. Specifically, the assessment platform 125 determines: (1) a frequency at which the user enters/exits the one or more POIs within a given period (e.g., a day, a week, a month, etc.); (2) a duration at which the user stays at the one or more POIs within the given period; (3) or a combination thereof. If the degree satisfies a threshold, the assessment platform 125 determines that the mobility pattern of the user validates the role of the user. For example, if a role indicates that a user is a doctor and the mobility pattern indicates that the user visits a hospital from 9 AM to 5 PM from Monday to Friday, the assessment platform 125 may validate the user as a doctor.

In one embodiment, a role may be associated with a function related to mobility. The function may indicate a route in which a user takes to fulfil responsibilities and/or work obligations thereof. For example, a function of a doctor, a firefighter, or a law enforcement officer may refer to the ability thereof to reach a hospital, a fire department, or a police station, respectively, while a function of a delivery driver may to refer to the ability thereof to reach multiple locations. In one embodiment, a function may be defined as a route from a user's residence to the user's workplace. In one embodiment, a function may be defined as a route from a location to multiple different locations. Information indicating a function may be used by the assessment platform 125 to determine an appropriate amount of charge to be provided to designated electric vehicles during an emergency.

Once the role of the user is validated, the assessment platform 125 may determine a priority of the user and add the user to the exception list based on the priority. In one embodiment, the assessment platform 125 may allow all electric vehicle users that are first responders to be included in the exception list. In one embodiment, a user of an electric vehicle may be added to the exception list based on an importance of a role of the user in a context of a given emergency. For example, if the emergency involves fire, the assessment platform 125 may prioritize adding firefighters to the exception list over law enforcement officers. In one embodiment, the assessment platform 125 may establish, for each of a plurality of different emergencies, a list of types of roles that is prioritized to be added to the exception list. In one embodiment, an order at which a list of types of roles is prioritized in the exception list may reflect: (1) an order at which electric vehicles corresponding to the roles receive power from the power source 115; (2) an amount at which electric vehicles as indicated in the exception list receive power from the power source 115 (e.g., the vehicle of the highest priority in the exception list receives a first level of power, whereas the vehicle of the lowest priority receives a second lower level of power). In one embodiment, electric vehicle users having occupational obligations unrelated to a given emergency may apply to be included in the exception list. In such embodiment, the assessment platform 125 may add such users to the exception list if the users are vouched through a credible source (e.g., a government officiated establishment). Alternatively or additionally, such users may indicate one or more types of function that will be performed for the given emergency, and the assessment platform 125 may add said users to the exception list if the type of function is an appropriate response for the given emergency and the mobility patterns of said users validate the types of function. By way of example, if an electric vehicle user provides information indicating that the user uses the electric vehicle to pick up and transport elderlies to a hospital for a critical routine check-up, the assessment platform 125 may validate the information by reviewing the mobility pattern of the user and determining a frequency at which the user transports the elderlies at a day-to-day basis.

For each electric vehicle user indicated in the exception list, the assessment platform 125 may determine an appropriate amount of charge to be provided to each electric vehicle as indicated in the exception list. Specifically, the assessment platform 125 may determine a predetermined amount of state of charge for each electric vehicle indicated in the exception list. In one embodiment, the predetermined amount of state of charge may be a maximum state of charge or less than the maximum state of charge. In one embodiment, the predetermined amount of state of charge may be calculated based on a function associated with a given role of an electric vehicle user as indicated in the exception list. For example, the predetermined amount of state of charge may be an amount of charge needed by an electric vehicle to traverse a distance from an electric vehicle user's residence to the user's workplace. By way of another example, the predetermined amount of state of charge may be an amount of charge needed by an electric vehicle to reach multiple locations (e.g., delivering items to multiple locations, picking up multiple persons, etc.). Further, for each electric vehicle user indicated in the exception list, assessment platform 125 may determine a charging medium 113 associated with said electric vehicle user. Generally, the assessment platform 125 will assume a residence of the electric vehicle user as the charging medium 113 that is associated with the electric vehicle user; however, if the electric vehicle user provides information indicating a specific charging medium 113, the assessment platform 113 may associate said charging medium 113 with the electric vehicle user.

The assessment platform 125 may transmit, to a power supplier, the exception list including information indicating a predetermined amount of state of charge for each vehicle indicated by the exception list and information indicating a charging medium 113 associated with said vehicle. During an emergency, the power supplier may use the exception list and the information to provide power to each electric vehicle indicated in the exception list while limiting or discontinuing provision of power to one or more electric vehicles excluded from the exception list. Once a state of charge of said electric vehicle reaches the predetermine amount of state of charge, the power supplier may limit or discontinue the provision of power to said vehicle. It is contemplated that provision of power to a charging medium 113 may be discontinued due to an indirect impact of an emergency or a direct impact thereof. An example of an indirect impact may be redistribution of power from one region of an electric grid to another. An example of a direct impact may be fire, flood, or tornado damaging a portion of an electric grid. For an event in which a power supplier is unable to provide power via a charging medium 113 associated with a designated electric vehicle due a direct impact of an emergency, the power supplier may transmit, to the assessment platform 125, a notification indicating the event, and in response, the assessment platform 125 may identify one or more alternative charging media 113 that is not impacted by the emergency or indirectly impacted by the emergency. In one embodiment, the one or more alternative charging media 113 may be proximate to the designated electric vehicle, the charging medium 113 associated with the designated electric vehicle, or a UE of the designated electric vehicle's user. In one embodiment, the one or more alternative charging media 113 may be proximate to or be within a route indicated by a function (e.g., a route from a user's residence to a user's workplace or a route to multiple locations). If a designated electric vehicle is coupled to an alternative charging medium 113, the designated electric vehicle or a UE of a user of the designated electric vehicle may transmit, to the assessment platform 125, a request to receive power at the alternative charging medium 113. In response, the assessment platform 125 transmits a request to a power supplier of the alternative charging medium 113 to enable provision of power at the alternative charging medium 113.

In one embodiment, when an emergency occurs, the assessment platform 125 may: (1) determine a time at which the emergency occurs; (2) determine one or more POIs associated with each designated electric vehicle; (3) determine whether the one or more POIs provides a type of service associated with a role of a user of said designated electric vehicle at the time or one or more future time points; and (4) determine a function and a predetermined amount of state of charge for the user based on the determination rendered at step (3). For example, a volunteer that drives elderlies from residences thereof to a hospital for a routine check-up may be included in the exception list. When an emergency occurs, the assessment platform 125 determines a time at which the emergency occurs and determines locations of residences of the elderlies and the hospital. The assessment platform 125 further determines whether the hospital provides the routine-check up at the time of the emergency. If the assessment platform 125 determines that the hospital does not provide such service at the time of the emergency, the assessment platform 125: (1) identifies an alternative hospital that provides the routine-check up at the time of the emergency; (2) modify the route for the volunteer to include the alternative hospital; and (3) establish the predetermined amount of state of charge based on the route.

In one embodiment, the assessment platform 125 ensures multiple designated electric vehicle users that share the same residence and designated electric vehicle to reach POIs associated with the users during an emergency. In such embodiment, the assessment platform 125 determines a route including POIs associated with the designated electric vehicle users and assigns a predetermined amount of state of charge for the designated electric vehicle to traverse the route. For example, if a family including a doctor and a law enforcement officer shares a designated electric vehicle and a residence, the assessment platform 125 may determine a route to a hospital and a police station and assign a predetermined amount of state of charge for the designated electric vehicle to traverse the route. In one embodiment, if multiple designated electric vehicle users share the same residence and own multiple electric vehicles, the assessment platform 125 ensures that at least one of the electric vehicles has a predetermined amount of state of charge for said electric vehicle to traverse from the residence to a POI associated with one of the electric vehicle users that is the farthest from the residence. For example, the assessment platform 125 may determine that: (1) a family includes a doctor and a law enforcement officer; (2) the family owns multiple designated electric vehicles and shares a residence; and (3) a hospital where the doctor works is 80 miles from the residence and a police department where the law enforcement officer works is 40 miles from the residence. During an emergency, if one of the designated electric vehicles is coupled to a charging medium 113, the assessment platform 125 ensures that said electric vehicle can be charged up to a predetermined amount of state of charge for said electric vehicle to traverse 80 miles.

During non-emergencies, the assessment platform 125 may monitor a state of charge of a designated electric vehicle and provide a notification if a current state of charge the designated electric vehicle falls below a predetermined amount of state of charge as indicated in the exception list. The notification may be provided to a UE or other user interface associated with the designated electric vehicle. In one embodiment, the assessment platform 125 may transmit such notification when a designated electric vehicle is at a location of a charging medium 113 but is not coupled to the charging medium 113. In one embodiment, the assessment platform 125 may transmit such notification when a designated electric vehicle is at a location of a charging medium 113 associated with the designated electric vehicle (as indicated in the exception list) but is not coupled to the charging medium 113.

In one embodiment, the assessment platform 125 integrates public transport (e.g., bus, train, bikes, scooters, etc.) as a means for transportation during emergencies. For example, if an electric vehicle user is not included in the exception list or there is no charging medium 113 available within a proximity of a designated electric vehicle, the assessment platform 125 may provide a route to a POI associated with a user that integrates public transportation.

In one embodiment, the assessment platform 125 may dispatch of a plurality of shared electric vehicles within one or more regions. A shared electric vehicle may be used by one or more users as indicated in the exception list. The availability of the shared electric vehicles may be provided via a plurality of UEs, and the shared electric vehicles may be reserved through the plurality of UEs. In one embodiment, the plurality of shared electric vehicles may be accessed only during an emergency. An option for accessing a shared electric vehicle may be provided to a UE of a user as indicated in the exception list. If the user opts out of using the shared electric vehicle or does not provide a response within a predetermined period, the assessment platform 125 may provide the same option to a subsequent user as indicated in the exception list.

In one embodiment, the assessment platform 125 provides a notification to the UE 101 indicating: (1) an occurrence of an emergency; (2) power limitation or discontinuation caused by the emergency; (3) areas impacted by the power limitation or discontinuation; (4) whether a user of an electric vehicle is included in the exception list; (5) a predetermined amount of charge associated with the user as indicated in the exception list; (6) a POI associated with the user as indicated in the exception list; (7) a function and/or a route associated with the user as indicated in the exception list; (8) other information relevant for providing availability of designated electric vehicles during an emergency; or (9) a combination thereof.

In the illustrated embodiment, the database 127 stores information on users included in the exception list, such as a role, a function, a predetermined amount of state of charge, etc. The database 127 may also store information on POIs, road links (e.g., road length, road breadth, slope information, curvature information, etc.), probe data for one or more road links (e.g., traffic density information), and other types map-related features. In one embodiment, the database 127 may include any multiple types of information that can provide means for aiding in providing availability of designated electric vehicles during an emergency. It should be appreciated that the information stored in the database 127 may be acquired from any of the elements within the system 100, other vehicles, sensors, database, or a combination thereof.

In one embodiment, the UE 101, the vehicle 105, the charging medium 113 (e.g., a charging station), the power source 115, the services platform 117, the content providers 121, the assessment platform 125 communicate with each other and other components of the communication network 123 using well known, new or still developing protocols. In this context, a protocol includes a set of rules defining how the network nodes within the communication network 123 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

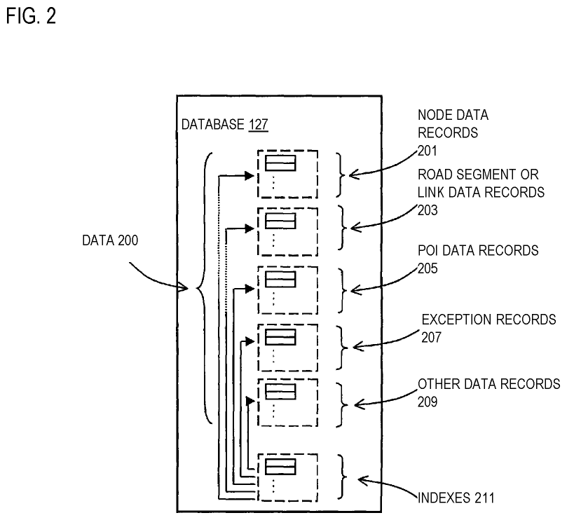

FIG. 2 is a diagram of a database 127 (e.g., a map database), according to one embodiment. In one embodiment, the database 127 includes data 200 used for (or configured to be compiled to be used for) mapping and/or navigation-related services, such as for personalized route determination, according to exemplary embodiments.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the database 127.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the database 127 follows certain conventions. For example, links do not cross themselves and do not cross each other except at a node or vertex. Also, there are no duplicated shape points, nodes, or links. Two links that connect each other have a common node or vertex. In the database 127, overlapping geographic features are represented by overlapping polygons. When polygons overlap, the boundary of one polygon crosses the boundary of the other polygon. In the database 127, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the database 127 is presented according to a hierarchical or multi-level tile projection. More specifically, in one embodiment, the database 127 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

As shown, the database 127 includes node data records 201, road segment or link data records 203, POI data records 205, exception records 207, other records 209, and indexes 211, for example. More, fewer or different data records can be provided. In one embodiment, additional data records (not shown) can include cartographic (“carto”) data records, routing data, and maneuver data. In one embodiment, the indexes 211 may improve the speed of data retrieval operations in the database 127. In one embodiment, the indexes 211 may be used to quickly locate data without having to search every row in the database 127 every time it is accessed.

In exemplary embodiments, the road segment data records 203 are links or segments representing roads, streets, or paths, as can be used in the calculated route or recorded route information for determination of one or more personalized routes. The node data records 201 are end points (such as intersections) corresponding to the respective links or segments of the road segment data records 203. The road link data records 203 and the node data records 201 represent a road network, such as used by vehicles, cars, and/or other entities. Alternatively, the database 127 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

Links, segments, and nodes can be associated with attributes, such as geographic coordinates, a number of road objects (e.g., road markings, road signs, traffic light posts, etc.), types of road objects, traffic directions for one or more portions of the links, segments, and nodes, traffic history associated with the links, segments, and nodes, street names, address ranges, speed limits, turn restrictions at intersections, presence of roadworks, and other navigation related attributes, as well as POIs, such as gasoline stations, hotels, restaurants, museums, stadiums, offices, automobile dealerships, auto repair shops, factories, buildings, stores, parks, etc. The database 127 can include data about the POIs and their respective locations in the POI data records 205. The data about the POIs may include attribute data associated with the POIs, such as: (1) a type of POI; (2) a classification of POI; (3) a type of personnel associated with the POI (e.g., occupational data associated with an employee of the P01); (4) a type of vehicle associated with the POI (e.g., a service vehicle associated with the P01); (5) one or more time points in which one or more vehicles associated with the POI enters and/or exists the POI (e.g., scheduled deliveries); (6) hours of operation associated with the POI; (7) directories associated with the POI; (8) types of services provided by the POI; or (9) a combination thereof. The database 127 can also include data about places, such as cities, towns, or other communities, and other geographic features, such as bodies of water, mountain ranges, etc. Such place or feature data can be part of the POI data records 205 or can be associated with POIs or POI data records 205 (such as a data point used for displaying or representing a position of a city).

The exception records 207 includes a plurality of exception lists. Each exception list may be associated with one or more types of emergencies and indicate one or more different types of users/electric vehicles. For each user/electric vehicle identified in the exception list, the exception records 207 indicates: (1) a role of the user; (2) a function of the user; (3) a predetermined amount of charge associated with the user; (4) one or more POIs associated with the user (e.g., a POI indicating a workplace of the user); (5) a residence of the user; (6) a charging medium 113 associated with the user; (7) a number of electric vehicles associated with the user; (8) one or more other designated electric vehicle users sharing the same residence as the user and information associated thereto; (9) other information associated with the user and/or the electric vehicle of the user; or (10) a combination thereof.

Other records 209 may include metadata associating roles and POIs. For example, such metadata may associate a role of a doctor to a hospital, a law enforcement office to a police station, a firefighter to a fire station, etc. Other records 209 may also include metadata that correlate one or more mobility patterns to one or more occupations of one or more users. For example, such metadata may indicate that a user is a doctor if the mobility pattern of the user indicates that the user stays at the hospital from 9 AM-5 PM from Monday to Friday. Other records 209 may indicate locations of charging media 113 that are not charging stations (e.g., a non-residential or residential building). Other records 209 may also indicate one or more regions impacted by an emergency, which may be periodically updated based on information received from a power supplier.

In one embodiment, the database 127 can be maintained by the services platform 117 and/or one or more of the content providers 121 in association with a map developer. The map developer can collect geographic data to generate and enhance the database 127. There can be different ways used by the map developer to collect data. These ways can include obtaining data from other sources, such as municipalities or respective geographic authorities. In addition, the map developer can employ field personnel to travel by vehicle along roads throughout the geographic region to observe attributes associated with one or more road segments and/or record information about them, for example. Also, remote sensing, such as aerial or satellite photography, can be used.

The database 127 can be a master database stored in a format that facilitates updating, maintenance, and development. For example, the master database or data in the master database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the vehicle 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received database in a delivery format to produce one or more compiled navigation databases.

The processes described herein for providing availability of designated electric vehicles during an emergency may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

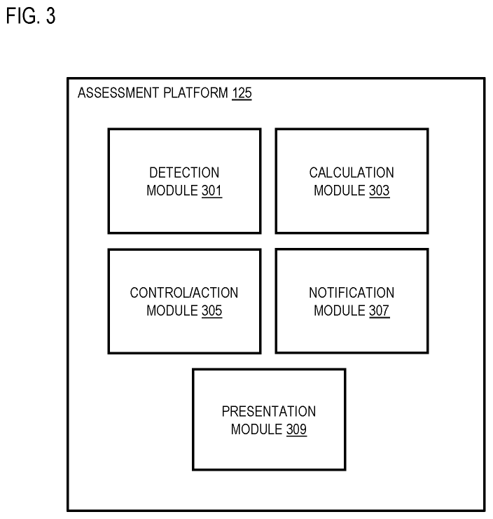

FIG. 3 is a diagram of the components of the assessment platform 125, according to one embodiment. By way of example, the assessment platform 125 includes one or more components for providing availability of designated electric vehicles during an emergency. It is contemplated that the functions of these components may be combined in one or more components or performed by other components of equivalent functionality. In this embodiment, the assessment platform 125 includes a detection module 301, a calculation module 303, a control/action module 305, a notification module 307, and a presentation module 309.

The detection module 301 is capable of acquiring data from the UE 101, the vehicle 105 (or one or more other vehicles similar to the vehicle 105), the charging medium 113, the power source 115, the services platform 117, the content providers 121, the database 127, a power supplier of the power source 115 or a combination thereof to provide availability of designated electric vehicles during an emergency. In one embodiment, the detection module 301 receive information indicating: (1) that an emergency is occurring; (2) one or more locations impacted by the emergency; (3) whether one or more portions of a power grid corresponding to the one or more locations is impacted (directly or indirectly) by the emergency; (4) one or more charging media 113 electrically coupled to the one or more portions of the power grid; or (5) a combination thereof. Such information may be provided by the charging medium 113, the power source 115, the services platform 117, the content providers 121 and/or the power supplier of the power source 115. In one embodiment, the detection module 301 receives a request for an electric vehicle to be charged during an emergency and/or a request for an electric vehicle user to be included in an exception list. Such request may be transmitted from electric vehicles (e.g., vehicle 105), UEs associated thereto (e.g., UE 101), or a combination thereof. In one embodiment, the detection module 301 may receive information associated with electric vehicles, such as: (1) a location of the electric vehicle; (2) one or more users associated with the electric vehicle; (3) whether an electric vehicle is being charged; (4) a state of charge of the electric vehicle; or (5) a combination thereof. Such information may be provided via the electric vehicles, UEs associated with said electric vehicles, the services platform 117, the content providers 121, or a combination thereof. In one embodiment, the detection module 301 may receive information associated with electric vehicle users, such as: (1) a role of user; (2) a function of the user; (3) a mobility pattern of the user; (4) a residence of the user; (5) one or more POIs associated with the role; (6) one or more electric vehicles associated with the user; or (7) a combination thereof. The detection module 301 may receive such information from the electric vehicles (e.g., vehicle 105) associated with the users, UEs (e.g., UE 101) associated with the electric vehicle users, the services platform 117, the content providers 121, or a combination thereof. In one embodiment, the detection module 301 may determine locations of charging media 113, such as charging stations and/or outlets being used as charging media 113.

The calculation module 303 is capable of: (1) adding electric vehicle users to an exception list based on the role thereof; (2) assigning a predetermined amount of state of charge for each user within the exception list; (3) providing alternative means of transportation during an emergency; or (4) a combination thereof. Specifically, the calculation module 303 may add a user to the exception list based on data provided by the detection module 301. At the outset, the detection module 301 may receive a request for an electric vehicle user to be added to the exception list. In response, the detection module 301 provides data indicating the role of the user, the mobility pattern of the user, and other data (e.g., a function of the user; a residence of the user, one or more POIs associated with the role, etc.) to the calculation module 303. The function may indicate a route in which a user takes to fulfil responsibilities and/or work obligations thereof. For example, a function of a doctor, a firefighter, or a law enforcement officer may refer to the ability thereof to reach a hospital, a fire department, or a police station, respectively, while a function of a delivery driver may to refer to the ability thereof to reach multiple locations. In one embodiment, a function may be defined as a route from a user's residence to the user's workplace. In one embodiment, a function may be defined as a route from a location to multiple different locations. Information indicating a function may be used by the calculation module 303 to determine an appropriate amount of charge to be provided to designated electric vehicles during an emergency.

The calculation module 303 validates the role based on a comparison between the mobility pattern of the user and one or more POIs associated with the role of the user. Specifically, the calculation module 303 determines a degree at which the one or more POIs is related with the mobility pattern. For example, the calculation module 303 determines: (1) a frequency at which the user enters/exits the one or more POIs within a given period (e.g., a day, a week, a month, etc.); (2) a duration at which the user stays at the one or more POIs within the given period; (3) or a combination thereof. If the degree satisfies a threshold, the calculation module 303 determines that the mobility pattern of the user validates the role of the user.

Once the role of the user is validated, the calculation module 303 may determines a priority of the user and add the user to the exception list based on the priority. In one embodiment, the calculation module 303 may allow all electric vehicle users that are first responders to be included in the exception list. In one embodiment, a user of an electric vehicle may be added to the exception list based on an importance of a role of the user in a context of a given emergency. For example, if the emergency involves fire, the calculation module 303 may prioritize adding firefighters to the exception list over law enforcement officers. In one embodiment, the calculation module 303 may establish, for each of a plurality of different emergencies, a list of types of roles. In one embodiment, the list may be prioritized based on an order. In such embodiment, the order at which the types of roles are prioritized in the exception list may reflect an order at which electric vehicles corresponding to the roles receive power from the power source 115 or an amount at which electric vehicles as indicated in the exception list receive power from the power source 115 (e.g., the vehicle of the highest priority in the exception list receives a first level of power, whereas the vehicle of the lowest priority receives a second lower level of power). In one embodiment, electric vehicle users having occupational obligations unrelated to a given emergency may apply to be included in the exception list. In such embodiment, the calculation module 303 may add such users to the exception list if the users are vouched through a credible source (e.g., a government officiated establishment). Alternatively or additionally, such users may indicate one or more types of function that will be performed for the given emergency, and the calculation module 303 may add said users to the exception list if the type of function is an appropriate response for the given emergency and the mobility patterns of said users validate the types of function. By way of example, if an electric vehicle user provides information indicating that the user uses the electric vehicle to pick up and transport elderlies to a hospital for a critical routine check-up, the calculation module 303 may validate the information by reviewing the mobility pattern of the user and determining a frequency at which the user transports the elderlies at a day-to-day basis.

For each electric vehicle user indicated in the exception list, the calculation module 303 may determine an appropriate amount of charge to be provided to each electric vehicle as indicated in the exception list. Specifically, the calculation module 303 may determine a predetermined amount of state of charge for each electric vehicle indicated in the exception list. In one embodiment, the predetermined amount of state of charge may be a maximum state of charge or less than the maximum state of charge. In one embodiment, the predetermined amount of state of charge may be calculated based on a function associated with a given role of an electric vehicle user as indicated in the exception list. For example, the predetermined amount of state of charge may be an amount of charge needed by an electric vehicle to traverse a distance from an electric vehicle user's residence to the user's workplace. By way of another example, the predetermined amount of state of charge may be an amount of charge needed by an electric vehicle to reach multiple locations (e.g., delivering items to multiple locations, picking up multiple persons, etc.). Further, for each electric vehicle user indicated in the exception list, calculation module 303 may determine a charging medium 113 associated with said electric vehicle user. Generally, the calculation module 303 will assume a residence of the electric vehicle user as the charging medium 113 that is associated with the electric vehicle user; however, if the electric vehicle user provides information indicating a specific charging medium 113, the assessment platform 113 may associate said charging medium 113 with the electric vehicle user.

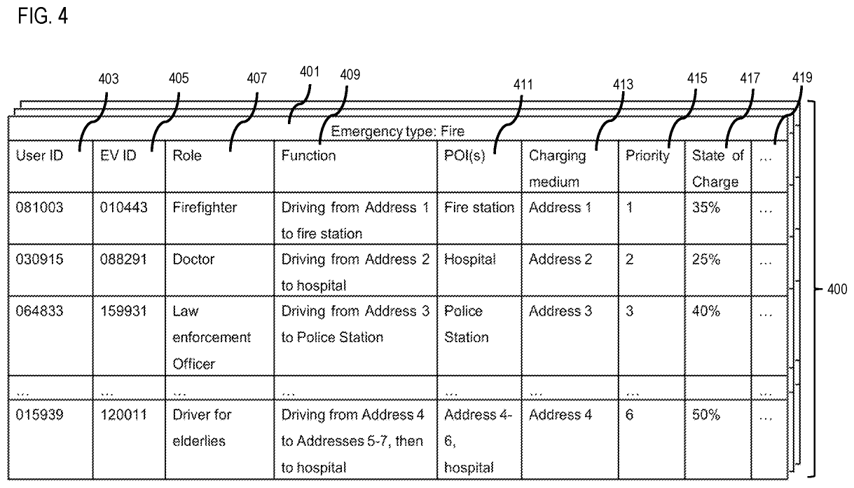

The calculation module 303 may establish a plurality of exception list, where each exception list is established based on a type of emergency that is impacting charging of electric vehicles. For example, FIG. 4 illustrates example exception lists established by the calculation module 303. In the illustrated example, the calculation module 303 has established a plurality of exception lists 400, where one of the exception lists 400 is established for an emergency associated with fire. Each exception list indicates: (1) a type of emergency (i.e., 401); (2) an electric vehicle user (i.e., 403); (3) an electric vehicle (i.e., 405); (4) a role of the user (i.e., 407); (5) a function of the user (i.e., 409); (6) one or more POIs associated with the user (i.e., 411); (7) a charging medium 113 at which the electric vehicle is attempting to be charged (i.e., 413); (8) a priority of user (i.e., 415); (9) a predetermined amount of state of charge (i.e. 417); and (10) other data associated with the user (i.e. 419). The other data may be a number of electric vehicles associated with the user, a number of other users of the electric vehicle, etc.

In one embodiment, when an emergency occurs, the calculation module 303 may: (1) determine a time at which the emergency occurs; (2) determine one or more POIs associated with each designated electric vehicle; (3) determine whether the one or more POIs provides a type of service associated with a role of a user of said designated electric vehicle at the time or one or more future time points; and (4) determine a function and a predetermined amount of state of charge for the user based on the determination rendered at step (3). For example, a volunteer that drives elderlies from residences thereof to a hospital for a routine check-up may be included in the exception list. When an emergency occurs, the calculation module 303 determines a time at which the emergency occurs and determines locations of residences of the elderlies and the hospital. The calculation module 303 further determines whether the hospital provides the routine-check up at the time of the emergency. If the calculation module 303 determines that the hospital does not provide such service at the time of the emergency, the calculation module 303: (1) identifies an alternative hospital that provides the routine-check up at the time of the emergency; (2) modify the route for the volunteer to include the alternative hospital; and (3) establish the predetermined amount of state of charge based on the route.

In one embodiment, the calculation module 303 ensures multiple designated electric vehicle users that share the same residence and designated electric vehicle to reach POIs associated with the users. In such embodiment, the calculation module 303 determines a route including POIs associated with the designated electric vehicle users and assigns a predetermined amount of state of charge for the designated electric vehicle to traverse the route. For example, if a family including a doctor and a law enforcement officer shares a designated electric vehicle and a residence, the calculation module 303 may determine a route to a hospital and a police station and assign a predetermined amount of state of charge for the designated electric vehicle to traverse the route. In one embodiment, if multiple designated electric vehicle users share the same residence and own multiple electric vehicles, the calculation module 303 ensures that one of the electric vehicles has a predetermined amount of state of charge for said electric vehicle to traverse from the residence to a POI associated with one of the electric vehicle users that is the farthest from the residence. For example, the calculation module 303 may determine that: (1) a family includes a doctor and a law enforcement officer; (2) the family owns multiple electric vehicles and shares a residence; and (3) a hospital where the doctor works is 80 miles from the residence and a police department where the law enforcement officer works is 40 miles from the residence. During an emergency, if one of the designated electric vehicles is coupled to a charging medium 113, the calculation module 303 ensures that said electric vehicle can be charged up to a predetermined amount of state of charge for said electric vehicle to traverse 80 miles.

During non-emergencies, the calculation module 303 may monitor, via the detection module 301, a state of charge of a designated electric vehicle and cause the notification module 307 to generate a notification if a current state of charge the designated electric vehicle falls below a predetermined amount of state of charge as indicated in the exception list. The notification may be provided to a UE or other user interface associated with the designated electric vehicle. In one embodiment, the calculation module 303 may cause the notification module 307 to generate such notification when a designated electric vehicle is at a location of a charging medium 113 but is not coupled to the charging medium 113. In one embodiment, the calculation module 303 may cause the notification module 307 to transmit such notification when a designated electric vehicle is at a location of a charging medium 113 associated with the designated electric vehicle (as indicated in the exception list) but is not coupled to the charging medium 113.

In one embodiment, the calculation module 303 integrates public transport (e.g., bus, train, bikes, scooters, etc.) as a means for transportation during emergencies. For example, if an electric vehicle user is not included in the exception list or there is no charging medium 113 available within a proximity of a designated electric vehicle, the calculation module 303 may generate a route to a POI associated with a user that integrates public transportation.

The control/action module 305 may transmit, to a power supplier, the exception list including information indicating a predetermined amount of state of charge for each vehicle indicated by the exception list and information indicating a charging medium 113 associated with said vehicle. In one embodiment, the control/action module 305 may generate a command signal that causes a power supplier to distribute power to each vehicle as indicated by the exception list. In one embodiment, the control/action module 305 embodies functions of a power supplier and manages/maintains power supplied from the power source 115 to all charging media 113 electrically coupled to the power source 115 based on the exception list. In one embodiment, the control/action module 305 may also identify one or more alternative charging media 113 that is not impacted by an emergency or indirectly impacted by the emergency. If a designated electric vehicle is coupled to an alternative charging medium 113, the designated electric vehicle or a UE of a user of the designated electric vehicle may transmit, to the calculation module 303, a request to receive power at the alternative charging medium 113. In response, the control/action module 305 may transmits a request to a power supplier of the alternative charging medium 113 to enable provision of power at the alternative charging medium 113. In one embodiment, the control/action module 305 may generate a signal to dispatch of a plurality of shared electric vehicles within one or more regions. A shared electric vehicle may be used by one or more users as indicated in the exception list during an emergency. The availability of the shared electric vehicles may be provided via a plurality of UEs, and the shared electric vehicles may be reserved through the plurality of UEs.

The notification module 307 may generate a notification associated with providing availability of designated electric vehicles during an emergency. The notification module 307 may cause the notification to the UE 101 and/or one or more other UEs associated with the vehicle 105. The notification may indicate: (1) an occurrence of an emergency; (2) power limitation or discontinuation caused by the emergency; (3) areas impacted by the power limitation or discontinuation; (4) whether a user of an electric vehicle is included in the exception list; (5) a predetermined amount of charge associated with the user as indicated in the exception list; (6) a POI associated with the user as indicated in the exception list; (7) a function and/or a route associated with the user as indicated in the exception list; (8) availability of public transport during the emergency; (9) availability of one or more shared electric vehicles; or (11) a combination thereof. The notification may include sound notification, display notification, vibration, or a combination thereof. In one embodiment, the notification module 307 may provide the notification to a local municipality/establishment.

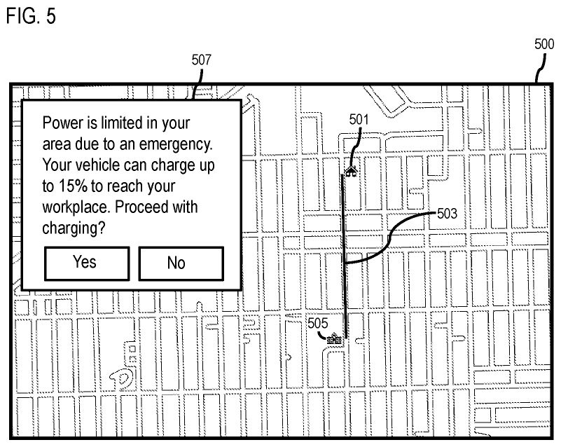

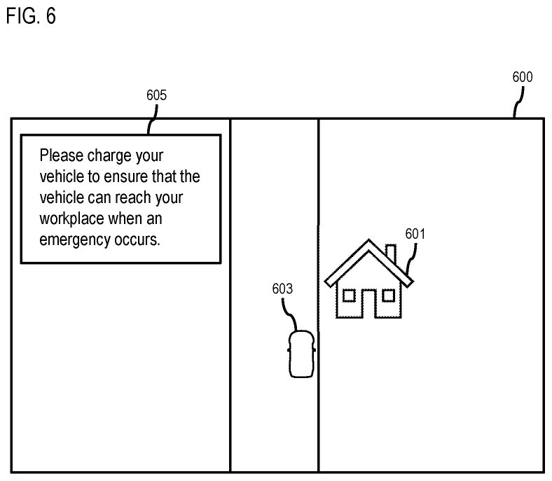

The presentation module 309 obtains a set of information, data, and/or calculated results from other modules, and continues with providing a presentation of a visual representation to the UE 101 and/or any other user interface associated with the vehicle 105. The visual representation may indicate any of the information presented by the notification module 307. For example, FIG. 5 illustrates a first example visual representation 500 of a prompt provided to a designated electric vehicle user during an emergency. The first visual representation 500 depicts a scenario in which provision of power is limited in an area including a residence 501 of an electric vehicle user. In such scenario, the electric vehicle user is included in the exception list. As such, the presentation module 307 displays a route 503 from the residence 501 to the electric vehicle user's workplace 505 and a prompt 507 stating “POWER IS LIMITED IN YOUR AREA DUE TO AN EMERGENCY. YOUR VEHICLE CAN CHARGE UP TO 15% TO REACH YOUR WORKPLACE. PROCEED WITH CHARGING?” FIG. 6 illustrates a second example visual representation 600 of a notification for ensuring availability of a designated electric vehicle. The second visual representation 500 depicts a scenario in which: (1) an electric vehicle user is included in the exception list; (2) there is no emergency impacting distribution of power to the electric vehicle user's residence 601; (3) the electric vehicle 603 is proximate to the residence 601; (4) the electric vehicle 603 is not electrically coupled to an outlet of the residence 601; and (5) the state of charge of the electric vehicle 603 is below a predetermined amount of state of charge associated with the electric vehicle 603, as indicated in the exception list. As such, the presentation module 307 displays a message 605 stating “PLEASE CHARGE YOUR VEHICLE TO ENSURE THAT THE VEHICLE CAN REACH YOUR WORKPLACE WHEN AN EMERGENCY OCCURS.” Other visual representations indicating availability of designated electric vehicles during an emergency are contemplated.

The above presented modules and components of the assessment platform 125 can be implemented in hardware, firmware, software, or a combination thereof. Though depicted as a separate entity in FIG. 3, it is contemplated that the assessment platform 125 may be implemented for direct operation by the UE 101, the vehicle 105, the services platform 117, one or more of the content providers 121, a power supplier associated with the charging medium 113 and the power source 115, or a combination thereof. As such, the assessment platform 125 may generate direct signal inputs by way of the operating system of the UE 101, the vehicle 105, the services platform 117, the one or more of the content providers 121, a power supplier associated with the charging medium 113 and the power source 115, or the combination thereof for interacting with the applications 103. The various executions presented herein contemplate any and all arrangements and models.

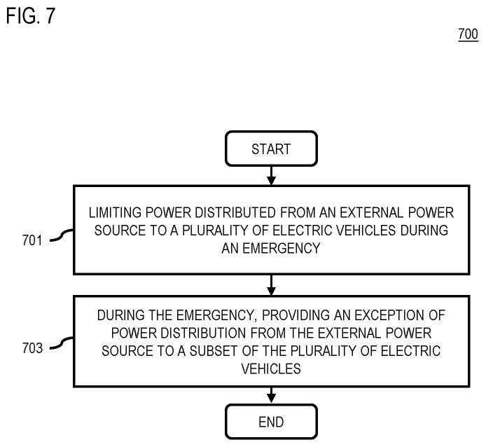

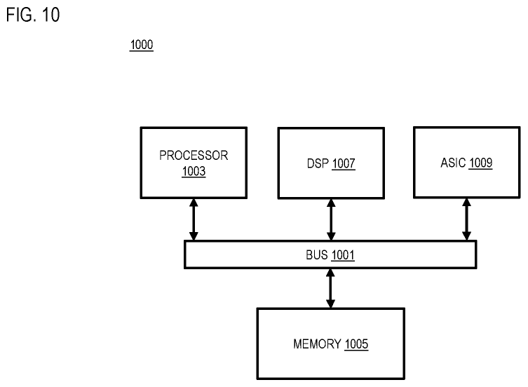

FIG. 7 is a flowchart of a process 700 for selectively providing power to electric vehicles during an emergency, according to one embodiment. In one embodiment, the assessment platform 125 performs the process 700 and is implemented in, for instance, a chip set including a processor and a memory as shown in FIG. 10.

In step 701, the assessment platform 125 limits power distributed from an external power source to a plurality of electric vehicles during an emergency. In one embodiment, the assessment platform 125 may transmit commands to a power supplier that controls the external power source, and in response, the power supplier limits power distributed from the external power source to a plurality of charging media 113 coupled with the plurality of electric vehicles. In one embodiment, the assessment platform 125 directly transmits commands to limit power distributed from the external power source such that an amount of power distributed to an electric vehicle coupled to a charging medium 113 during an emergency is less than an amount of power distributed to the electric vehicle coupled to the charging medium 113 during a non-emergency.

In step 703, the assessment platform 125 provides an exception of power distribution from the external power source to a subset of the plurality of electric vehicles during the emergency. The exception ensures a predetermined amount of state of charge for each of the subset during the emergency. The exception is established at least in part by a mobility pattern of a user of each of the plurality of electric vehicles. Specifically, an electric vehicle is added to the subset based on a role of a user of the electric vehicle. If the role is prioritized for an emergency, the assessment platform 125 includes the electric vehicle of the user as the subset. For example, if an emergency requires firefighters and a user's role is a firefighter, the user's electric vehicle may be added to the subset. In one embodiment, the assessment platform 125 may validate a role of an electric vehicle user based on a mobility pattern of the user. For example, referring to the previous example, the assessment platform 125 may analyze the mobility pattern of the user to determine: (1) a frequency at which the user enters/leaves a fire station; (2) a duration at which the user stays at the fire station each day; or (3) a combination thereof. If the mobility pattern of the user indicates that the user works at the fire station, the assessment platform 125 may validate the role of the user as a firefighter. In one embodiment, the predetermined amount of state of charge may ensure that a user of each of electric vehicle can reach the user's workplace from the user's charging location (e.g., the user's residence).

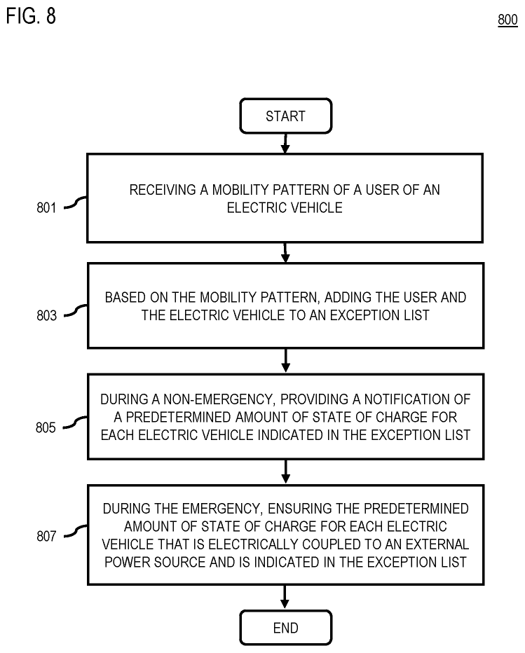

FIG. 8 is a flowchart of a process 800 for ensuring availability of designated electric vehicles during an emergency. In one embodiment, the assessment platform 125 performs the process 700 and is implemented in, for instance, a chip set including a processor and a memory as shown in FIG. 10.

In step 801, the assessment platform 125 receives a mobility pattern of a user of an electric vehicle. The mobility pattern may indicate: (1) a frequency at which the user enters/leaves a POI; (2) a duration at which the user stays at the POI each day; or (3) a combination thereof. The assessment platform 125 may analyze the mobility pattern to verify a role of the user. For example, if the mobility pattern indicates that the user visits a hospital from 9 AM to 5 PM from Monday to Friday, the assessment platform 125 may determine that the user is a doctor.

In step 803, the assessment platform 125 adds the user and the electric vehicle to an exception list based on the mobility pattern. Specifically, the assessment platform 125 prioritizes certain roles (e.g., first responders) in view of an emergency, and if the mobility pattern of the user validates that that a role of the user is one of said roles, the assessment platform 125 adds the user and the electric vehicle thereof to the exception list. For example, if a user claims that a role thereof is a doctor, the assessment platform 125 validates the user's claim by analyzing the mobility pattern of the user. In such example, if the mobility pattern indicates that the user frequently visits a hospital and stays at the hospital, the assessment platform 125 may add the user and the electric vehicle thereof to the exception list.

In step 805, the assessment platform 125 provides a notification of a predetermined amount of state of charge for each electric vehicle indicated in the exception list during a non-emergency. Specifically, the assessment platform 125 provides the notification to said electric vehicle and/or a UE associated therewith to recommend that said vehicle should be charged up to the predetermined amount of state of charge, thereby ensuring that said electric vehicle has a sufficient amount of charge to traverse to a POI (e.g., the user's workplace) associated with the user when an emergency occurs. In one embodiment, the assessment platform 125 provides such notification if said electric vehicle is not electrically coupled to a charging medium 113. In one embodiment, the assessment platform 125 provides such notification if said electric vehicle is proximate the user's residence.

In step 807, the assessment platform 125 ensures the predetermined amount of state of charge for each electric vehicle that is coupled to an external power source and is indicated in the exception list during the emergency. In one embodiment, the predetermined amount of state of charge may ensure that a user of each electric vehicle can reach the user's workplace from the user's charging location (e.g., the user's residence).

The system, apparatus, and methods described herein enable a map-based server/platform to ensure availability of electric vehicles, thereby enabling essential workers to use electric vehicles thereof for performing designated duties thereof during an emergency. Further, since the system, apparatus, and methods described herein provides, during an emergency, power to consumers whose roles are validated based on mobility patterns of the consumers, energy management is improved during emergencies.

The processes described herein may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

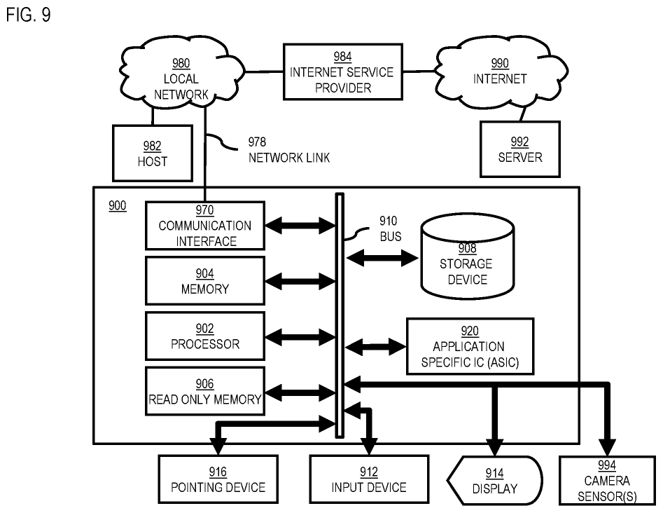

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide availability of designated electric vehicles during an emergency as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing availability of designated electric vehicles during an emergency.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing availability of designated electric vehicles during an emergency. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for providing availability of designated electric vehicles during an emergency. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing availability of designated electric vehicles during an emergency, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 123 for providing availability of designated electric vehicles during an emergency to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 982 connected to the Internet hosts a process that provides a service in response to information received over the Internet. For example, server host 982 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 982 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide availability of designated electric vehicles during an emergency as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing availability of designated electric vehicles during an emergency.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real-time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors. The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide availability of designated electric vehicles during an emergency. The memory 1005 also stores the data associated with or generated by the execution of the inventive steps.

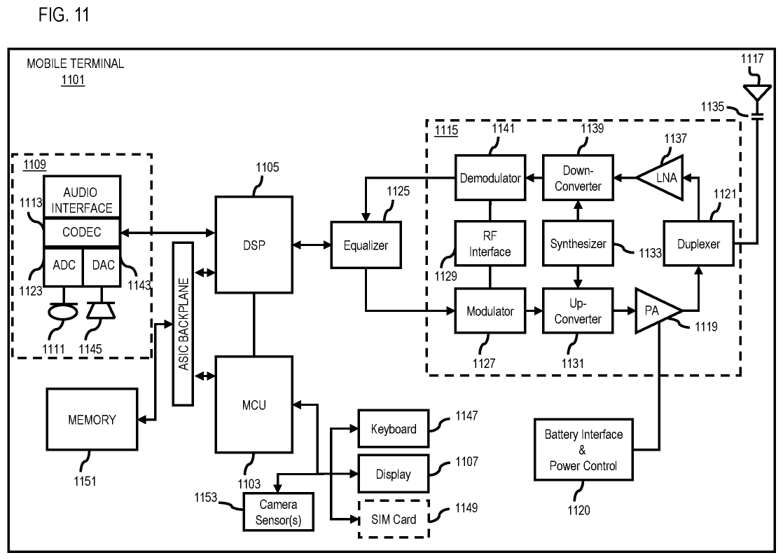

FIG. 11 is a diagram of exemplary components of a mobile terminal 1101 (e.g., a mobile device or vehicle or part thereof) for communications, which is capable of operating in the system of FIG. 1, according to one embodiment. In some embodiments, mobile terminal 1101, or a portion thereof, constitutes a means for performing one or more steps of providing availability of designated electric vehicles during an emergency. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing availability of designated electric vehicles during an emergency. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide availability of designated electric vehicles during an emergency. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

We (I) claim:

1. An apparatus comprising at least one processor and at least one non-transitory memory including computer program code instructions, the computer program code instructions configured to, when executed, cause the apparatus to:
limit power distributed from an external power source to a plurality of electric vehicles during an emergency; and
during the emergency, provide an exception of power distribution from the external power source to a subset of the plurality of electric vehicles, wherein the exception ensures a predetermined amount of state of charge for each of the subset during the emergency, and wherein the exception is established at least in part by a mobility pattern of a user of each of the plurality of electric vehicles.

2. The apparatus of claim 1, wherein the exception is further established at least in part by occupational information associated with the user of each of the plurality of electric vehicles.

3. The apparatus of claim 2, wherein the occupational information associated with the user of each of the subset indicate an occupation designated for the emergency, and wherein the mobility pattern of the user of each of the subset validates the occupational information associated with the user of each of the subset.

4. The apparatus of claim 3, wherein the predetermined amount of state of charge is determined based on a distance from a charging location associated with each of the subset to an occupational point-of-interest (POI) associated with the user of each of the subset.

5. The apparatus of claim 4, wherein the charging location is a residential location associated with the user of each of the subset.

6. The apparatus of claim 1, wherein the computer program code instructions are configured to, when executed, cause the apparatus to, during the emergency:
cause the external power source to distribute, at most, a first level of power to each of a remaining number of the plurality of electric vehicles that is excluded from the subset; and
cause the external power source to distribute, at least, a second greater level of power to each of the subset.

7. The apparatus of claim 1, wherein the mobility pattern is acquired via the user's electric vehicle, a mobile device associated with the user, or a combination thereof.

8. A non-transitory computer-readable storage medium having computer program code instructions stored therein, the computer program code instructions, when executed by at least one processor, cause the at least one processor to:
receive a mobility pattern of a user of an electric vehicle;
based on the mobility pattern, add the user and the electric vehicle to an exception list; and
during an emergency, ensure a predetermined amount of state of charge for each electric vehicle that is electrically coupled to an external power source and is indicated in the exception list.

9. The non-transitory computer-readable storage medium of claim 8, wherein the computer program code instructions, when executed by the at least one processor, cause the at least one processor to:
receive occupational information associated with the user; and
based further on the occupational information, add the user and the electric vehicle to the exception list.

10. The non-transitory computer-readable storage medium of claim 9, wherein the computer program code instructions, when executed by the at least one processor, cause the at least one processor to, responsive to the occupational information indicating an occupation designated for the emergency and the mobility pattern validating the occupational information, add the user and the electric vehicle to the exception list.

11. The non-transitory computer-readable storage medium of claim 10, wherein the predetermined amount of state of charge is determined based on a distance from a charging location associated with each electric vehicle as indicated in the exception list to an occupational point-of-interest (POI) associated with each user as indicated in the exception list.

12. The non-transitory computer-readable storage medium of claim 11, wherein the charging location is a residential location associated with each user as indicated in the exception list.

13. The non-transitory computer-readable storage medium of claim 8, wherein the computer program code instructions, when executed by the at least one processor, cause the at least one processor to, during the emergency, limit power distributed from the external power source to one or more electric vehicles excluded from the exception list

14. The non-transitory computer-readable storage medium of claim 13, wherein the computer program code instructions, when executed by the at least one processor, cause the at least one processor to, during the emergency:
cause the external power source to distribute, at most, a first level of power to each of the one or more electric vehicles; and
cause the external power source to distribute, at least, a second greater level of power to each electric vehicle as indicated in the exception list.

15. The non-transitory computer-readable storage medium of claim 14, wherein the computer program code instructions, when executed by the at least one processor, cause the at least one processor to, during the emergency, responsive to a state of charge for each electric vehicle as indicated in the exception list reaching the predetermined amount of state of charge, cause the external power source to distribute, at most, the first level of power to each electric vehicle as indicated in the exception list.

16. The non-transitory computer-readable storage medium of claim 8, wherein the mobility pattern is acquired via the electric vehicle, a mobile device associated with the user, or a combination thereof.

17. A method of ensuring availability of electric vehicles during an emergency, the method comprising:
receiving a mobility pattern of a user of an electric vehicle;
based on the mobility pattern, adding the user and the electric vehicle to an exception list;
during a non-emergency, providing a notification of a predetermined amount of state of charge for each electric vehicle indicated in the exception list; and
during the emergency, ensuring the predetermined amount of state of charge for each electric vehicle that is coupled to an external power source and is indicated in the exception list.

18. The method of claim 17, further comprising:
receiving occupational information associated with the user; and
based further on the occupational information, adding the user and the electric vehicle to the exception list.

19. The method of claim 18, further comprising, responsive to the occupational information indicating an occupation designated for the emergency and the mobility pattern validating the occupational information, adding the user and the electric vehicle to the exception list.

20. The method of claim 19, wherein the predetermined amount of state of charge is determined based on a distance from a charging location associated with each electric vehicle as indicated in the exception list to an occupational point-of-interest (POI) associated with each user as indicated in the exception list.
